(19) United States
(12) Patent Application Publication
(10) Pub. No.: US 2024/0065152 A1
(43) Pub. Date: Feb. 29, 2024

(54) SYSTEM AND METHOD FOR OPTIMIZED DETERMINATION OF MACHINE PARAMETERS OF AN AGRICULTURAL PRODUCTION MACHINE

(71) Applicant: CLAAS Selbstfahrende Erntemaschinen GmbH, Harsewinkel (DE)

(72) Inventors: Bastian Bormann, Gütersloh (DE); Waldemar Thiesmann, Osnabrück (DE); Joachim Baumgarten, Beelen (DE); Andreas Wilken, Bissendorf (DE); Heinrich Warkentin, Gütersloh (DE); Mohamed Altaleb, Lemgo (DE); Henning Deeken, Osnabrück (DE)

(73) Assignee: CLAAS Selbstfahrende Erntemaschinen GmbH, Harsewinkel (DE)

(21) Appl. No.: 18/238,591

(22) Filed: Aug. 28, 2023

(30) Foreign Application Priority Data
Aug. 26, 2022 (DE) 10 2022 121 701.9
Jan. 12, 2023 (DE) 10 2023 100 640.1

(51) Int. Cl. A01D 41/127

(52) U.S. Cl. CPC A01D 41/127

(57) ABSTRACT

A method and system for the optimized determination of machine parameters of an agricultural production machine is disclosed. The agricultural production machine has a driver assistance system and a sensor assembly and performs an agricultural task in a local context. A determination routine the driver assistance system uses the strategy specifications as input parameters of the instruction for use to determine the optimized machine parameters optimized with respect to the strategy specifications as output parameters of the instruction for use, wherein the strategy is parameterized with initial strategy parameters at the beginning of the execution of the agricultural task. The driver assistance system uses strategy parameters as the initial strategy parameters that have already been optimized by at least one agricultural production machine in a similar local context.

### CROSS REFERENCE TO RELATED APPLICATION

This application claims priority under 35 U.S.C. § 119 to German Patent Application No. DE 10 2022 121 701.9 filed Aug. 26, 2022, and to German Patent Application No. DE 10 2023 100 640.1 filed Jan. 12, 2023, the entire disclosure of both of which are hereby incorporated by reference herein. This application is also related to U.S. application Ser. No. ______ (attorney docket number 15191-23021A (P05636/8), incorporated by reference herein in its entirety.

### TECHNICAL FIELD

The present invention relates to a method for optimized determination of machine parameters of an agricultural production machine and to an agricultural production machine configured for optimized determination of machine parameters of the agricultural production machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

There are many different kinds of agricultural production machines. By way of examples, agricultural production machines may comprise harvesting machines (e.g., combine harvesters and forage harvesters) and prime movers (e.g., tractors).

Agricultural production machines may be adapted to their particular agricultural task using a variety of working parameters (interchangeably termed machine parameters). These working parameters may, for example, be any one, any combination, or all of: an engine speed; a threshing drum speed; a PTO shaft torque; the gap of a grain cracker; the driving speed; and the like. There are various approaches to optimize these working parameters with respect to certain objectives. For example, this optimization may be performed by the user himself/herself (who may be the driver of the agricultural production machine), in cooperation with a driver assistance system, or fully automated.

For example, the user may assign strategy specifications to the driver assistance system (e.g., select a predefined strategy or weight several competing optimization goals). The driver assistance system may convert these strategy specifications into optimized working parameters with the aid of an application instruction, which may be map-based, for example. In turn, the optimized working parameters may be used to automatically control one or more aspects of the agricultural production machine.

US Patent Application Publication No. 2012/0004812 A1, incorporated by reference herein in its entirety, describes how, in agricultural machines, optimized working parameters may be determined from strategy specifications (such as the selection criteria and optimization criteria therein) of a user of the agricultural production machine via an application instruction (such as the characteristic curves therein in combination with the automatic controllers). The application instruction may, in principle, be adapted or modified to the local context, for example by involving or receiving input from an external consultant who contributes expert knowledge.

In U.S. Pat. No. 9,002,594 B2, incorporated by reference herein in its entirety, the application instruction, which may comprise the family of characteristics (maps for short), may be successively improved in the field during the execution of an agricultural task, such as by approaching different working points in order to take into account the influence of the local context (e.g., weather, climate, crop types, soil types, etc.) on the theoretical family of characteristics.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates an example of the disclosed method.

FIG. 2a illustrates the determination routine.

FIG. 2b illustrates the optimization routine.

### DETAILED DESCRIPTION

As discussed in the background, optimization of the working parameters may be performed. However, a problem with successive optimization of the working parameters with regard to the local context is that this may require a certain amount of time, such as 30 minutes, to determine or parameterize the maps to such an extent that optimized working parameters may then be determined from the maps for various changes in the field conditions, for example. For this purpose, the agricultural production machine may, for example, run through several non-optimized operating points (e.g., combinations of operating parameters) in order to determine interpolation points of the map or maps. During this optimization routine, the agricultural production machine therefore may operate with changing and non-optimal settings of working parameters.

Therefore, it may be a challenge to arrive at optimized machine parameters faster and/or more efficiently.

Thus, in one or some embodiments, one consideration may comprise the optimization routine being shortened or even omitted if one or more optimized strategy parameters are used that have already been optimized in a similar local context. In particular, these strategy parameters may be used to start the optimization routine so that it is already closer to the optimized machine parameters for the specific local context, as opposed to selecting the strategy parameters without considering the local context and without using strategy parameters that have already been optimized in another local context. To select the optimized strategy parameters, in one or some embodiments, one or more aspects of the current local context for agricultural production machine to perform the agricultural task may be compared with the same local context with the other local context. If there is a match (e.g., one, some, or each of the aspects of the current local context for agricultural production machine is identical to the same local context or the other local context (e.g., a same location); one, some, or each of the aspects of the current local context for agricultural production machine are within a predefined amount (such as a predefined distance) from the same or the other local context), then the strategy parameters (previously optimized for the other local context) may then be used as initial strategy parameters in order to generate one or more optimized machine parameters, thereby, making it easier to identify or select the optimized machine parameters (effectively capitalizing on the previously optimization of the strategy parameters previously performed for the other local context). This may thus be a significant improvement as compared to previous optimization routines, which may use the same initial strategy parameters regardless of the local context. This may also make it possible to use the analysis of many already optimized machine parameters to better adjust those agricultural production machines to the local context that cannot make these adjustments themselves. For example, the agricultural production machines may be given a table with optimized machine parameters depending on sensor measurement data, user defaults and/or further machine parameter settings from which the driver assistance system then draws the optimized machine parameters.

In one or some embodiments, the driver assistance system may use strategy parameters (selected based at least in part on the local context) as the initial strategy parameters that have already been optimized by at least one agricultural production machine in a similar local context.

In one or some embodiments, a control assembly is disclosed which has a database with stored strategy parameters. From these strategy parameters, the control assembly may be configured to select suitable strategy parameters depending on the particular local context and may transmit the suitable strategy parameters to the driver assistance system. The larger the database with the strategy parameters becomes, the higher the probability of being able to determine strategy parameters from the database that may already fit the local context very well. For example, average values from many strategy parameters of agricultural production machines used in similar contexts may be used as initial strategy parameters.

In one or some embodiments, the agricultural production machine is configured go automatically perform an optimization routine during the execution of the agricultural task and therefore may successively further optimize the initial strategy parameters. Advantageously, this optimization routine may be shortened by the improved initial strategy parameters and/or may at least already be started with more optimal machine parameters during the optimization routine. The machine parameters optimized in this way may be transferred or transmitted back to the control assembly (e.g., for storage in the database).

In one or some embodiments, the user may also intervene in the optimization of the agricultural production machine and therefore may function, more or less, as a human sensor and human optimization routine. Together with the optimization routine of the driver assistance system, jointly optimized strategy parameters may therefore be determined, which are also be based on the expert knowledge of the user. These optimized strategy parameters may also be transmitted to the control assembly (e.g., for storage in the database).

One embodiment of the strategy and in particular of the instruction for use in which at least one map is used to determine the optimized machine parameters. In the simplest case, these may simply be read from the map depending on the input parameters. In particular, however, it may be provided that the strategy comprises a cost function which, as part of the instruction for use, weights the strategy specifications. The goal of the cost function may be to minimize predefined costs, whereby the minimum of the cost function may indicate where the machine parameters are optimal for the given strategy specifications. An input or change of the strategy specifications may thus be reflected in a change of weights of the cost function.

In one or some embodiments, various option of how the optimization routine may be designed are contemplated. According to this, the driver assistance system may approach interpolation points of the characteristic map by actually setting associated machine parameters on the agricultural production machine and measuring the resulting influences on the strategy specifications using data generated by the sensor assembly, directly or indirectly. From the interpolation points, the coefficients and/or a shift of a map may be determined. Due to the improved initial strategy parameters, there may be the possibility of only shifting the map or maps in the optimization routine and making no or only minor changes to the coefficients.

As previously mentioned, the optimization routine may be dependent on the initial strategy parameters (e.g., selected based on the local context). Accordingly, the interpolation points may be selected depending on the initial strategy parameters, and/or the optimization routine may be shortened. This may result in an overall more efficient execution of the agricultural task and greater user acceptance.

In one or some embodiments, the initial strategy parameters may comprise optimized machine parameters, and that these may be set initially in the agricultural production machine until the optimization routine has at least slightly progressed. Therefore, especially at the start of the execution of the agricultural task, a more efficient execution of the same is achieved.

The initial strategy parameters may include strategy specifications and/or initial strategy parameters of the instruction for use. Therefore, for example, it may be provided that strategy specifications which are set by other users in similar local contexts are initially used. The user may still change these subsequently.

With regard to the instruction for use, the interface with the user in the form of strategy specifications may be constant, but “under the hood” may lead to a different result for the optimized machine parameters. This is a description of the one operation of the strategy, such as the instruction for use.

In one or some embodiments, the control assembly may be arranged or positioned externally to the agricultural production machine and may be accessible via the Internet (e.g., resident in an Internet server).

Various ways are contemplated to determine similarity of the local context or contents of the local context data. For example, the initial strategy parameters may be passed from day to day in the same agricultural production machine. Therefore in the simplest case, the agricultural production machine may begin operation the next day with the initial strategy parameters already optimized the previous day. However, other time intervals (other than one day) are contemplated. For example, the time interval may also be a longer time, such as a whole season.

In one or some embodiments, initial strategy parameters may be transferred between different agricultural production machines on the same field or a field located close by. In particular, initial strategy parameters may be transferred between agricultural production machines. This may be useful, for example, if one of the agricultural production machines starts performing the agricultural task later or is not able to determine optimized strategy parameters itself. The probability of a similar local context may be higher for nearby fields. In this regard, one aspect to determine similarity may comprise distance between the fields.

In one or some embodiments, the similarity of the local contexts may be determined via a degree of similarity, which may take into account climatic zones of the particular local contexts. It has been found that agricultural production machines in different climatic zones may have differently optimized machine parameters even with the same strategy specifications, and that sometimes different strategy specifications may also be used. This influence of climate zones may not be taken into account in previous driver assistance systems, which may always use the same initial strategy parameters, such as the same initial map. However, the initial optimization of the machine parameters may be improved particularly efficiently here using a big data approach. For example, the control assembly may contain strategy specifications of many agricultural production machines sorted by climate zones, and their values (such as their mean values) may be used as initial strategy specifications.

In one or some embodiments, the climate zones may be divided into similar climate zones according to the Köppen-Geiger classification.

In one or some embodiments, the disclosed methodology may be used for a combine harvester. It has been shown that the dependence on climatic zones may lead to significantly different optimized machine parameters in a combine harvester.

In one or some embodiments, an agricultural production machine is configured for optimized adjustment of machine parameters of the agricultural production machine, thereby performing any one, any combination, or all of the functions described herein.

In one or some embodiments, the driver assistance system is configured to use strategy parameters as the initial strategy parameters that have already been optimized by at least one agricultural production machine in a similar local context.

The disclosed methodology may be applied to a wide range of agricultural production machines, such as to harvesting machines. This may include combine harvesters, forage harvesters, tractors, and the like.

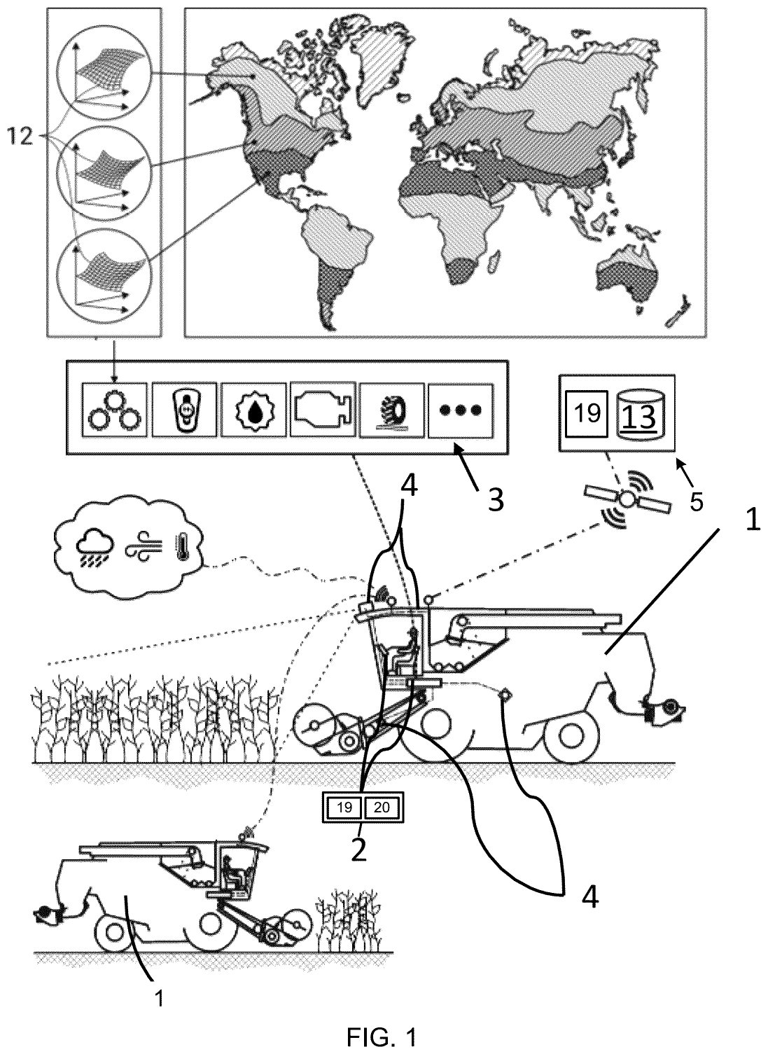

Such agricultural production machines 1 are used for a variety of different agricultural tasks. FIG. 1 shows an example of a harvesting operation. In these agricultural tasks, very different machine parameters may be set on the agricultural production machines 1. In one or some embodiments, the machine parameters are machine parameters in the narrow sense, such as any one, any combination, or all of: the engine speed; a position of a choke valve; settings of the rear power lift; or the like. In principle, however, the machine parameters may be indirectly set by the driver assistance system 2, for example by generating control signals for a dedicated control unit of a working unit and transmitting them to the dedicated control unit.

These machine parameter settings may have a strong influence on the result of the agricultural task. For example, it is possible to harvest a field quickly or, competitively, to achieve a high harvest quality.

In one or some embodiments, a method for the optimized determination of machine parameters of an agricultural production machine 1 is disclosed.

In one or some embodiments, the optimization of the machine parameters may comprise a process in which an optimization goal exists in principle, but is by no means always achieved. Optimized machine parameters 3 may therefore be neither optimal nor necessarily always more optimal than before. In one or some embodiments, optimized machine parameters 3 may merely be the result of an optimization. Also, not all target values of the optimization may necessarily be detectable by sensors, such as not always directly detectable, but possibly only indirectly derivable.

The agricultural production machine 1 has a driver assistance system 2 and a sensor assembly 4, which may communicate with one another. As schematically indicated in FIG. 1, the agricultural production machine 1 performs an agricultural task in a local context.

In one or some embodiments, the local context may comprise some or all influencing variables that in fact exist at or in the place where the agricultural task is performed (e.g. locally) and that may have an influence on the result of the agricultural task. Insofar as the term is used here, however, the local context may mean only that part of these influencing variables, which may also be known by the agricultural production machine 1, such as by the driver assistance system 2 and/or by the control assembly 5 (discussed further below).

The driver assistance system 2 may comprise at least one processor 19 and at least one memory 20 for saving data, software (e.g., routines discussed herein). The processor 19 may be configured to execute the software stored in the memory 20 (or in another memory device), which may comprise a non-transitory computer-readable medium that stores instructions that when executed by processor performs any one, any combination, or all of the functions described herein. Thus, the various routines described herein may comprise software routines, which may be executed by processor 19. In this regard, the processor 19 may comprise any type of computing functionality, such as a microprocessor, controller, PLA, or the like, and the memory 20 may comprise any type of storage device (e.g., any type of memory). As shown in FIG. 1, processor 19 and memory 20 are depicted as separate elements. Alternatively, processor 19 and memory 20 may be part of a single machine, which includes a microprocessor (or other type of controller) and a memory. Alternatively, processor 19 may rely on memory 20 for all of its memory needs.

The processor 19 and memory 20 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The influencing variables may be measured, but may also be obtained from a weather service, for example. The local context may comprise any one, any combination, or all of: the weather; the climate; a crop type; variety; harvesting conditions (such as a straw or grain moisture); selected crop protection measures; a degree of maturation; or a soil condition. Additionally, a machine configuration may be taken into account. GPS data may be used to determine the local context.

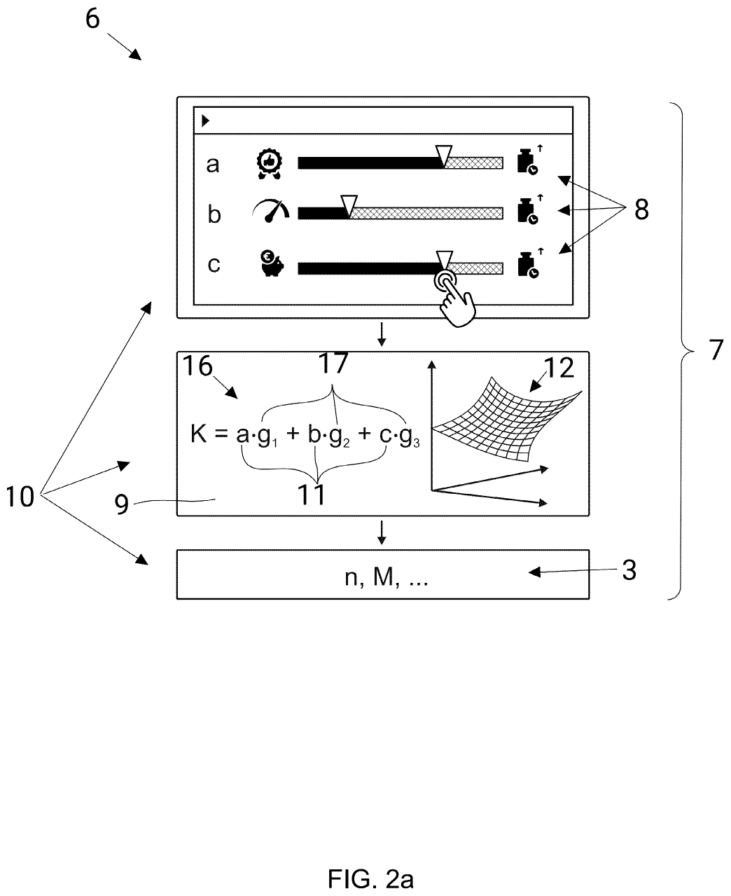

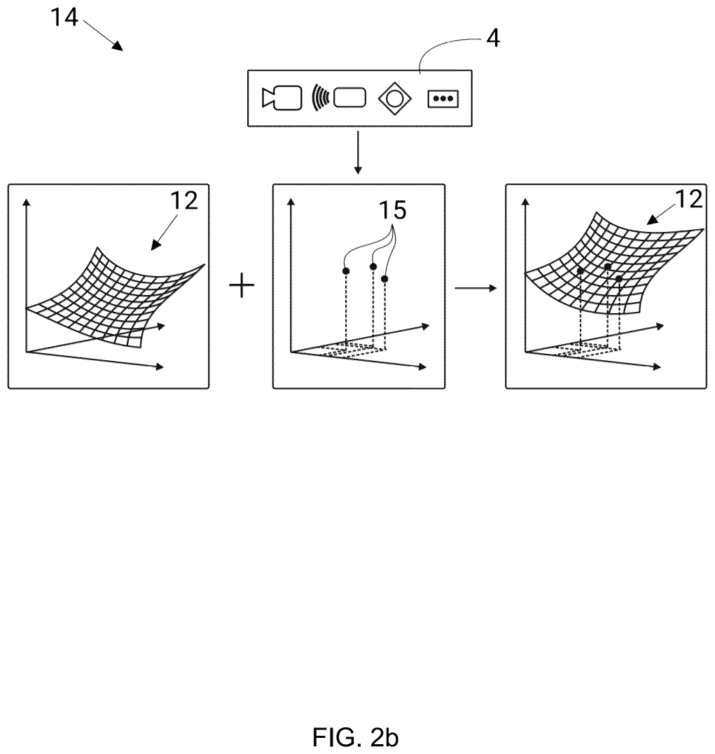

The driver assistance system 2 may then automatically determine machine parameters 3, optimized using a parameterizable strategy 7, for the agricultural production machine 1 for performing the agricultural task in a determination routine 6. After automatically determining the machine parameters 3, the driver assistance system 2 may at least partly automatically implement the machine parameters 3 (e.g., without any operator input for fully automatic implementation in order to control one or more aspects of the agricultural production machine 1; or by outputting one or more of the machine parameters 3 to obtain approval or rejection from an operator of the agricultural production machine 1, and after receiving approval from the operator, automatically implementing one or more of the machine parameters 3). This process is shown abstractly in FIG. 2a and will be explained further below.

The strategy 7 may comprise strategy specifications 8, an instruction for use 9 and the optimized machine parameters 3. Very generally, the strategy 7 may be parameterizable using strategy parameters 10 for adaptation or tailoring to a local context, as will also be explained further.

In the determination routine 6, the driver assistance system 2 may use the strategy specifications 8 as input parameters of the instruction for use 9 to determine the optimized machine parameters 3 as as outputs, such as output parameters of the instruction for use 9. The optimized machine parameters 3 may thereby be optimized with respect to the strategy specifications 8.

In order to then determine the optimized machine parameters 3 for a new agricultural task, the driver assistance system 2 may parameterize the strategy 7 with initial strategy parameters at the beginning of the execution of the agricultural task. The initial strategy parameters may still be adapted or updated during the execution of the agricultural task.

Strategy specifications 8 may include abstract strategies 7 and/or weightings of quality criteria 59. In this case, the abstract strategies 7 may comprise any one, any combination, or all of: a machine-friendly strategy 7 with low wear of the autonomous agricultural production machine 1; an eco-mode with low energy consumption but longer working time; fast working with higher fuel consumption; a higher harvesting quality with more time; or a high throughput with lower harvesting quality. The quality criteria 59 may comprise competing quality criteria 59 for which the user may graphically set a weighting, as exemplified in FIG. 2a for three quality criteria 59. The graphical display (which may comprise a touchscreen) thereby may visualize the competition between the quality criteria 59. The optimization may consequently be a multi-objective optimization. In this case, the strategy specifications 8 may be specified by the user.

In one or some embodiments, each quality criterion may very generally be defined by a goal of optimizing or adjusting a work process parameter. The term “optimization” may in the simplest case comprise maximization or minimization of the particular work process parameter. The term “setting” may mean that the particular work process parameter is to have a particular value, and the driver assistance system 2 may optimize the machine parameters to have that value, if possible. The quality criteria 59 may be selected from the list comprising “threshing out”, “broken grain fraction”, “separation losses”, “cleaning losses”, “threshing unit drive slip”, “fuel consumption”, “throughput”, “cleanliness” and “straw quality”. For example, a work process parameter 25 may be a travel speed or a harvested material throughput. The work process parameters 25 may be automatically adjusted by the interaction of machine-related machine parameters 25 with local conditions.

In one or some embodiments, the driver assistance system 2 may use strategy parameters 10 as the initial strategy parameters that have already been optimized by at least one agricultural production machine 1 in a similar local context. For example, the initial strategy parameters may have been optimized by one agricultural production machine 1, or strategy parameters 10 of several agricultural production machines 1 may be linked. Further, the initial strategy parameters may have been optimized by the same agricultural production machine 1 and/or by different agricultural production machine(s) 1. Further, the local context may be the same local context (exactly identical with all aspects of the local context being the same) or similar (e.g., one or more aspects of the local context are the same but one or more other aspects of the local context being different).

Initial strategy parameters may be strategy parameters 10 that are used at the beginning of the execution of the agricultural task to parameterize the strategy 7. In one embodiment, the initial strategy parameters may comprise initial coefficients of maps 12 of the instruction for use 9, as will be explained. These initial coefficients may be used to parameterize initial maps 12. The initial maps 12 may be used at the beginning of the execution of the agricultural task. Overall, therefore, the term “initial” as used herein may refer to the beginning of an agricultural task.

Instead of the agricultural production machine 1 starting with a default configuration, the agricultural production machine 1 may use initial strategy parameters that have a higher chance of more closely and quickly approaching an optimum of the machine parameters.

In one or some embodiments, the strategy parameters 10 may include strategy specifications 8, coefficients 11 of maps 12, and the like. A degree of similarity may be defined to determine similarity, or climate zones may be used as will be explained.

The optimized machine parameters 3 may be set by the driver assistance system 2 in the agricultural production machine 1 and may be used to perform at least a part of the agricultural task.

FIG. 1 shows that in this case, a control assembly 5 may be provided for distributing or transmitting optimized initial strategy parameters. In one or some embodiments, the control assembly 5 may be part of the agricultural production machine 1, such as the driver assistance system 2. Alternatively, as depicted in FIG. 1, control assembly 5 may be arranged externally thereto. In the following, example steps of the method while using a control assembly 5 will be explained.

The control assembly 5 may have a database 13 with stored strategy parameters 10 and associated data on local contexts (e.g., the stored strategy parameters are correlated to data on local contexts). The database 13 may be part of the control assembly 5 or external thereto. The stored strategy parameters 10 may have been previously successively optimized by driver assistance systems 2 of agricultural production machines 1 in optimization routines 14 during the execution of agricultural tasks in local contexts from initial strategy parameters for adaptation to the particular local context. This may be historical and/or current daily data, which may originate from the vicinity or from all over the world.

Further, control assembly 5 may include at least one processor 19. In this regard, control assembly may comprise computing functionality as discussed above with regard to driver assistance system 2.

In this case, the driver assistance system 2 may automatically determine context data of the local context of the agricultural task, such as by using the sensor assembly 4, and automatically transmit context data of the local context of the agricultural task to the control assembly 5. In addition or alternatively, the control assembly 5 may also determine the context data itself, such as from GPS data of the agricultural production machine 1. The determination may also be limited to a pure selection (e.g., the operator of the agricultural production machine 1 may select the context data). In this case, however, mean values of a plurality of initial strategy parameters may be formed from similar contexts, or they may otherwise be linked and transmitted as initial strategy parameters. When averaging, the initial strategy parameters from similar contexts may be weighted, such as depending on a confidence level of the data and/or a similarity index. Additionally or alternatively, several initial strategy parameters, which may be far apart and therefore potentially form local maxima, may be sampled.

Based on a comparison of the received context data with the context data from the database 13, the control assembly 5 may automatically determine initial strategy parameters adapted or tailored to the local context and automatically transmit them to the driver assistance system 2 of the agricultural production machine 1.

The driver assistance system 2 may automatically use the transmitted initial strategy parameters as initial strategy parameters.

Furthermore, in one or some embodiments, the agricultural production machine 1 may automatically determine sensor data relating to the achievement of the strategy specifications 8 using the sensor assembly 4 during the execution of the agricultural task, such as at the beginning of the execution of the agricultural task, in an optimization routine 14 automatically controlled by the driver assistance system 2, and that the driver assistance system 2 may successively automatically optimize the initial strategy parameters based on the sensor data in the optimization routine 14 and therefore may further optimize the optimized machine parameters 3.

In this way, the initial strategy parameters may be used as a starting point of the optimization routine 14, which may yield better results at the beginning of the optimization routine 14. Also, because of this, the optimization routine 14 may more quickly converge.

In addition, a transfer of initial strategy parameters and their use analogous to the described use in later phases of the automatic execution of the agricultural task may be provided. In particular, the agricultural production machine 1 may automatically compare its own performance with the performance of other agricultural production machines 1 and, depending on the performance, again may automatically use initial strategy parameters of another agricultural production machine 1. Subsequently, an optimization routine 14 may optionally be performed again. In the event of a sensor failure that impedes or prevents the execution of an optimization routine 14, initial strategy parameters of other agricultural production machines 1 may be used regularly, for example in the event of changes in the local context.

In one or some embodiments, the driver assistance system 2 may subsequently automatically transmit the thus-optimized strategy parameters 10 and the context data to the control assembly 5.

Likewise, in one or some embodiments, the user may adjust at least one, such as several, of the strategy parameters 10 after and/or during the optimization routine 14, such that the driver assistance system 2 may automatically transmit the thereby jointly optimized strategy parameters 10 and the context data to the control assembly 5.

Of particular interest is the possibility of supplementing the optimization by the driver assistance system 2 by also recording how the user reacts to this optimization. In this way, errors or inadequacies in the optimization routine 14 may be detected. Furthermore, these may be automatically corrected, if necessary, in that the control assembly 5 may also access this jointly optimized data in the future.

In this case, the user may set the strategy specifications 8 and/or optimization criteria. In principle, it may nevertheless also be provided that he intervenes more deeply in the system and even adjusts machine parameters individually.

The disclosed solution may be particularly suitable in the case that the strategy 7 comprises at least one map 12, which may depict relationship(s) between the machine parameters and the strategy specifications 8, such as in the form of mathematical functions. Such maps 12 are illustrated in FIGS. 1 and 2a-b. It may be difficult to impossible to precisely depict the operation of an agricultural production machine 1 mathematically at all conceivable working points and taking into account all interrelationships. However, it is possible to model some working points and interrelationships and therefore achieve good optimization results within certain limits. Using interpolation points 15, which are yet to be explained, an initial map may be adapted to the local context. In this case, several maps 12 may be provided which, for example, may depict individual working units of the agricultural production machine 1.

By means of the instruction for use 9, the driver assistance system 2 may automatically determine the optimized machine parameters 3 based on the strategy specifications 8 from the map or maps 12. In particular, the driver assistance system 2 may simply automatically read the optimized machine parameters 3 from the maps 12.

In one or some embodiments, the map or maps 12 may have coefficients 11, which parameterize the mathematical functions. These may be determined or corrected in this case from the interpolation points 15.

As an alternative to one or more maps 12, a tabular representation of empirically determined correlations may also be provided, which may replace the maps 12. Especially in this case, it may be advantageous if the tabular representation is adapted to the context. The tabular representation is not necessarily further optimized in an optimization routine 14.

In the embodiment shown in FIG. 2a, the strategy 7 may comprise a cost function 16. The cost function 16 may weight the strategy specifications 8 with weights 17. FIG. 2a illustrates a simplified example of such a cost function 16. The weights may correspond to the weightings of the quality criteria discussed above or be derived from them, but may also be more or less independent of them.

By means of the instruction for use 9, the driver assistance system 2 may automatically determine the optimized machine parameters 3 from the map or maps 12 in such a way that the cost function 16 aims at a predefined goal, such as the goal of minimizing costs of the cost function 16.

In one or some embodiments, the weights 17 may be chosen such that minimum costs of the cost function 16 maximizes the achievement of the strategy specifications 8.

In one or some embodiments, the driver assistance system 2 may automatically set various machine parameters in the optimization routine 14, which may form interpolation points 15 of the map 12 or maps 12, and may determine the coefficients 11 and/or at least one shift of a map 12 from the interpolation points 15.

At the beginning of an agricultural task, the driver assistance system 2 may know little about the local physical influences. In this case, the driver assistance system 2 may therefore set some machine parameters to non-optimal values in order to measure the effect. These settings may form the interpolation points 15 from which the map or maps 12 are determined. This process may take some time, which is why the improved initial strategy specifications 8 may have a significant effect on the work result, especially during this initial period.

In this case, the duration of the optimization routine 14 may be shortened, such as by reducing the number of interpolation points 15. For this purpose, it may be provided that at least one, such as several, coefficients 11 of the map 12 or the maps 12 initially derived from the strategy specifications 8 may no longer be changed, but the characteristic map 12 may only be shifted.

In particular, the optimization routine 14 may be dependent on the initial strategy parameters, such that the driver assistance system 2 may automatically select the interpolation points 15 depending on the initial strategy parameters, and/or that the optimization routine 14 may be shortened depending on the initial strategy parameters compared to an optimization routine 14 based on non-context-dependent initial strategy parameters.

For example, a map 12 may be reduced in size since the probability of larger deviations of the initial operating point (e.g., the initial optimized machine parameters 3) from the theoretical optimum is very likely to be smaller.

It is also contemplated that a suitable map 12 or suitable maps 12 is or are selected in the optimization routine 14 from a number of predefined maps 12 using the interpolation points 15.

In one variation, the initial strategy parameters may include optimized machine parameters 3.

In one or some embodiments, the driver assistance system 2 may initially automatically set the optimized machine parameters 3 of the initial strategy parameters as optimized machine parameters 3 in the agricultural production machine 1 and may only set the machine parameters 3 optimized in the determination routine 6 in the agricultural production machine 1 during or after the optimization routine 14.

Therefore, the agricultural production machine 1 may start directly with suitable machine parameters, records measurement data for this operating point for the first time, for example, and then successively varies the machine parameters to determine further interpolation points 15.

Alternatively, the machine parameters determined from the instruction for use 9 may also be set as optimized machine parameters 3 initially and/or substantially during the entire performance of the agricultural task.

In one or some embodiments, the initial strategy parameters comprise strategy specifications 8 and/or initial strategy parameters of the instruction for use 9, and the initial strategy parameters of the instruction for use 9 may comprise weights 17 of the cost function 16 and/or coefficients 11 of the maps 12.

Alternatively, the initial strategy parameters may include other cost functions 16 or other maps 12 in the form of other mathematical functions of the maps 12.

In one or some embodiments, the strategy specifications 8 may include not only optimized machine parameters 3 and/or not only strategy specifications 8. Even if optimized machine parameters 3 are transmitted, the driver assistance system 2 may automatically determine and automatically set optimized machine parameters 3 over the course of performing the agricultural task.

In one or some embodiments, the strategy specifications 8 are selected by the user, in particular in a terminal (e.g., touchscreen) of the agricultural production machine 1. This process is visualized in FIG. 2a using competing strategy specifications 8.

In this case, the driver assistance system 2 may generally be designed in such a way that the same strategy specifications 8 may lead to different optimized machine parameters 3, depending on the strategy parameters 10. Wherein the same strategy specifications 8 may lead to different optimized machine parameters 3 depending on the initial strategy parameters, in particular weights 17 of the cost function 16, even with theoretically identical maps 12. It need not be provided that these variants are actually performed; these may instead be descriptions of the mode of operation.

As mentioned above, the control assembly 5 may be arranged or positioned externally to the agricultural production machine 1. The control assembly 5 may be formed by one or more servers and communicate with the agricultural production machine 1 via the Internet. Additionally or alternatively, the database 13 may store a plurality of strategy parameters 10 which may originate from other, such as similar (e.g., have one or more aspects of the agricultural production machine in common), agricultural production machines 1.

The control assembly 5 may also be arranged or positioned on the agricultural production machine 1 or be divided between the agricultural production machine 1 and an external part (e.g., an Internet server). In the latter case, in particular long-term strategy parameters 10, in particular climate-dependent strategy parameters 10, may be stored locally and short-term strategy parameters 10 may be stored externally. In case of a disconnection, the local strategy parameters 10 may be used.

Like agricultural production machines 1 are those which basically have extremely similar behavior (e.g., agricultural production machines 1 of the same type with the same equipment).

In the following, sources will be explained from which the initial strategy parameters may originate, whether or not they are transmitted via the control assembly 5. The initial strategy parameters may have been optimized by the same agricultural production machine 1 in the same or similar local context. In particular, it may be the case that the initial strategy parameters have been optimized by the same agricultural production machine 1 within at most 14 days prior to the current day, or that the initial strategy parameters may have been optimized in a past season, such as the same season. Therefore, it may be provided that the same agricultural production machine 1 will use its own optimization results as initial strategy parameters in the future. As an alternative to the season, comparable periods of a crop cycle or crop year may also be used, especially if the distribution of sowing, harvesting, etc. varies between the different locations.

The other mentioned variants may occur in different agricultural tasks in the same agricultural production machine 1, such as depending on which initial strategy parameters are available and/or how similar the local contexts are, or the initial strategy specifications 8 are transferred between agricultural production machines 1, possibly indirectly via the control assembly 5.

In this case, the current local context and the local context of the used initial strategy parameters, such as transmitted by the control assembly 5, may be the same field or a close field, and the initial strategy parameters may have been optimized by another agricultural production machine 1.

This case may be particularly interesting when an agricultural production machine 1 later moves to a field or cannot perform an optimization routine 14.

It is further provided in this case that the similarity of the local contexts may be determined via a degree of similarity (e.g., one or more aspects of the local context), such as by the control assembly 5, and the degree of similarity may take climatic zones of the particular local contexts into account, such as primarily into account.

In one or some embodiments, climatic zones may have a significant influence on the function of agricultural production machines 1. This influence may be due to differences in soil, field conditions, but also in the behavior of the agricultural production machine 1 under different environmental conditions. Further, manual operators may choose different machine parameter settings in different climatic zones.

The term “primary” may mean that only initial strategy specifications 8 are acceptable where the context data pertain to the same climate zone.

Therefore, in this case, initial strategy parameters of agricultural production machines 1 in the same climate zones may be used, such as those that are currently performing an agricultural task or have done so within the past 24 hours. Single initial strategy parameters or linked initial strategy parameters, such as averaged initial strategy parameters, may be used.

It is further provided in this case that the climatic zones may be divided into similar climatic zones according to the Köppen-Geiger classification.

In one or some embodiments, the agricultural production machine 1 is a combine harvester, and the optimized machine parameters 3 may comprise the threshing drum speed and/or the gap width of the threshing drum. In this regard, after the optimized machine parameters 3 are determined, the optimized machine parameters 3 may be automatically implemented, thereby modifying operation of the agricultural production machine 1 (e.g., one or more aspects of the threshing drum).

According to another teaching, an agricultural production machine 1 may be configured for the optimized determination of machine parameters of the agricultural production machine 1, wherein the agricultural production machine 1 has a driver assistance system 2 and a sensor assembly 4, wherein the agricultural production machine 1 is configured to perform an agricultural task in a local context, wherein the driver assistance system 2 is configured to determine optimized machine parameters 3 for the agricultural production machine 1 for performing the agricultural task in a determination routine 6 by means of a parameterizable strategy 7, wherein the strategy 7 comprises strategy specifications 8, an application rule 9 and the optimized machine parameters 3, and wherein the strategy 7 may be parameterized by strategy parameters 10 for adaptation to a local context, wherein the driver assistance system 2 is configured to use the strategy specifications 8 as input parameters of the instruction for use 9 in the determination routine 6 in order to determine the optimized machine parameters 3 that have been optimized with respect to the strategy specifications 8 as output parameters of the instruction for use 9, and wherein the driver assistance system 2 is configured to parameterize the strategy 7 with initial strategy parameters at the beginning of the execution of the agricultural task in order to determine the optimized machine parameters 3. In turn, the optimized machine parameters 3 may be automatically implemented in order to modify operation of the agricultural production machine 1.

In one or some embodiments, the driver assistance system 2 is configured to use strategy parameters 10 as the initial strategy parameters that have already been optimized by at least one agricultural production machine 1 in a similar local context.

This agricultural production machine 1 may be used in this case in the disclosed methodology, and is therefore particularly configured for use in the disclosed methodology. Reference may be made to all statements regarding the proposed method.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural production machine
2 Driver assistance system
3 Optimized machine parameter
4 Sensor assembly
5 Control assembly
6 Determination routine
7 Strategy
8 Strategy specifications
9 Instruction for use
10 Strategy parameter
11 Coefficients
12 Map
13 Database
14 Optimization routine
15 Interpolation point
16 Cost function
17 Weights
18 Processor
19 Memory

1. A method for determining machine parameters of an agricultural production machine, wherein the agricultural production machine has a driver assistance system and a sensor assembly, and performs an agricultural task in a local context, the method comprising:
determining whether at least one aspect of the local context for performing the agricultural tasks is identical or within a predefined amount to a same local context or to an other local context;
responsive to determining that the at least one aspect of the local context for performing the agricultural tasks is identical to the same local context or to the other local context, selecting one or more strategy parameters previously optimized by at least one agricultural machine in the same local context or in the other local context;
wherein a strategy uses the one or more strategy parameters that were selected as initial strategy parameters in a strategy, wherein the strategy comprising strategy specifications, an instruction for use, and optimized machine parameters, and wherein the strategy is parameterized by the one or more strategy parameters that were selected in order to adapt the strategy to the local context;
determining, using the strategy, one or more optimized machine parameters for the agricultural production machine in order to perform the agricultural task, whereby the strategy, with the one or more strategy parameters as the initial strategy parameters, uses the strategy specifications as input for the instruction for use in order to generate the one or more optimized machine parameters as outputs; and
automatically, using the one or more optimized machine parameters, controlling at least a part of the agricultural production machine.

2. The method of claim 1, wherein a control assembly has a database of stored strategy parameters correlated to data on local contexts;
wherein the stored strategy parameters of driver assistance systems of agricultural production machines have been successively optimized in optimization routines during execution of agricultural tasks in a variety of local contexts from initial strategy parameters for adaptation to the local context of the agricultural task;
wherein the driver assistance system determines context data of the local context of the agricultural task using the sensor assembly;
wherein the driver assistance system transmits the context data to the control assembly;
wherein the control assembly determines the one or more strategy parameters as the initial strategy parameters based on comparing the transmitted context data with the context data stored in the database;
wherein the control assembly transmits the one or more strategy parameters as the initial strategy parameters to the driver assistance system of the agricultural production machine; and
wherein the driver assistance system uses the one or more strategy parameters as the initial strategy parameters to determine the one or more optimized machine parameters.

3. The method of claim 1, wherein the agricultural production machine determines sensor data relating to achievement of the strategy specifications using sensor data generated by the sensor assembly and indicative of execution of the agricultural task;
wherein the driver assistance system successively generates the one or more optimized machine parameters during the execution of the agricultural task including generating the initial strategy parameters at a beginning of the execution of the agricultural task and successively generating subsequent strategy parameters in order to successively optimize operation of the agricultural production machine.

4. The method of claim 3, wherein a user of the agricultural production machine adjusts at least one of the strategy parameters to generate jointly optimized strategy parameters one or both of during or after executing an optimization routine; and
wherein the driver assistance system transmits the jointly optimized strategy parameters and context data of the local context of the agricultural task to a control assembly.

5. The method of claim 1, wherein the strategy comprises at least one map which depicts one or more relationships between the machine parameters and the strategy specifications;
wherein using the instruction for use, the driver assistance system determines the optimized machine parameters based on the strategy specifications from the at least one map; and
wherein the map has a plurality of coefficients which parameterize mathematical functions.

6. The method of claim 5, wherein the strategy comprises a cost function;
wherein the cost function weights the strategy specifications, in that using the instruction for use, the driver assistance system determines the one or more optimized machine parameters from the at least one map by using the cost function to minimize costs of the cost function.

7. The method of claim 6, wherein the driver assistance system sets various machine parameters in an optimization routine, which form interpolation points of the at least one map; and
wherein the driver assistance system determines one or both of the plurality of coefficients or at least one shift of the at least one map from the interpolation points.

8. The method of claim 7, wherein one or both:
the driver assistance system selects the interpolation points depending on the initial strategy parameters; or
execution of the optimization routine is shortened responsive to using the initial strategy parameters based on the local context as compared to execution of the optimization routine based on non-context-dependent initial strategy parameters.

9. The method of claim 7, wherein the driver assistance system, executing the optimization routine, initially sets the optimized machine parameters of the initial strategy parameters as optimized machine parameters in the agricultural production machine; and
wherein the driver assistance system only executes a determination routine to set the machine parameters during or after executing the optimization routine.

10. The method of claim 1, wherein the initial strategy parameters comprise one or both of the strategy specifications or initial strategy parameters of the instruction for use; and
wherein the initial strategy parameters of the instruction for use comprise one or both of weights of a cost function or coefficients of at least one map depicting relationships between the machine parameters and the strategy specifications.

11. The method of claim 1, wherein the strategy specifications are selected by a user of the agricultural production machine via a terminal of the agricultural production machine.

12. The method of claim 1, wherein a same strategy specification leads to different optimized machine parameters depending on the strategy parameters; and
wherein the same strategy specification leads to the different optimized machine parameters depending on the initial strategy parameters including weights of a cost function.

13. The method of claim 2, wherein the control assembly is positioned externally to the agricultural production machine and formed by one or more servers and communicates with the agricultural production machine via an Internet; and
wherein a plurality of strategy parameters originating from other agricultural production machines is stored in the database and correlated to the variety of local contexts.

14. The method of claim 1, wherein the initial strategy parameters have been optimized by a same agricultural production machine as performing the agricultural task in the local context in a same or a similar local context.

15. The method of claim 1, wherein determining whether at least one aspect of the local context is identical or within the predefined amount to the other local context comprises determining based on location or distance of the local context to the other local context; and
wherein the initial strategy parameters were optimized by another agricultural production machine.

16. The method of claim 1, wherein determining whether at least one aspect of the local context is identical or within the predefined amount to the other local context is determined via a degree of similarity by determining whether a climatic zone is the same for both the local context and the other local context.

17. The method of claim 16, wherein the climatic zones are divided into similar climatic zones according to Köppen-Geiger classification.

18. The method of claim 1, wherein the agricultural production machine is a combine harvester; and
wherein the optimized machine parameters are one or both of a threshing drum speed or a gap width of a threshing drum.

19. An agricultural production machine configured for optimized determination of one or more machine parameters of the agricultural production machine, the agricultural production machine is configured to perform an agricultural task in a local context, the agricultural production machine comprising:
a sensor assembly; and
a driver assistance system in communication with the sensor assembly, the driver assistance system configured to:
determine whether at least one aspect of the local context for performing the agricultural tasks is identical or within a predefined amount to a same local context or to an other local context;
responsive to determining that the at least one aspect of the local context for performing the agricultural tasks is identical to the same local context or to the other local context, select one or more strategy parameters previously optimized by at least one agricultural machine in the same local context or in the other local context, wherein a strategy uses the one or more strategy parameters that were selected as initial strategy parameters in a strategy, wherein the strategy comprising strategy specifications, an instruction for use, and optimized machine parameters, and wherein the strategy is parameterized by the one or more strategy parameters that were selected in order to adapt the strategy to the local context;
determine, using the strategy, one or more optimized machine parameters for the agricultural production machine in order to perform the agricultural task, whereby the strategy, with the one or more strategy parameters as the initial strategy parameters, uses the strategy specifications as input for the instruction for use in order to generate the one or more optimized machine parameters as outputs; and
automatically, using the one or more optimized machine parameters, control at least a part of the agricultural production machine.

20. The agricultural production machine of claim 19, wherein the agricultural production machine is configured to communicate with a control assembly that has a database of stored strategy parameters correlated to data on local contexts;
wherein the stored strategy parameters of driver assistance systems of agricultural production machines have been successively optimized in optimization routines during execution of agricultural tasks in a variety of local contexts from initial strategy parameters for adaptation to the local context of the agricultural task;
wherein the driver assistance system is configured to determine context data of the local context of the agricultural task using the sensor assembly;
wherein the driver assistance system is configured to transmit the context data to the control assembly;
wherein, responsive to transmitting the context data, the driver assistance system is configured to receive the one or more strategy parameters as the initial strategy parameters to the driver assistance system of the agricultural production machine, with the one or more strategy parameters being determined based on the control assembly comparing the transmitted context data with the context data stored in the database; and
wherein the driver assistance system uses the one or more strategy parameters as the initial strategy parameters to determine the one or more optimized machine parameters.
